(19) United States
(12) Patent Application Publication
(10) Pub. No.: US 2025/0284559 A1
(43) Pub. Date: Sep. 11, 2025

(54) Multi-Cluster Carbon Aware Balancing

(71) Applicant: International Business Machines Corporation, Armonk, NY (US)

(72) Inventors: Krishnasuri Narayanam, Bangalore (IN); Asser Nasreldin Tantawi, Somers, NY (US); Alaa S. Youssef, Valhalla, NY (US); Tayebeh Bahreini, Lewisville, TX (US)

(21) Appl. No.: 18/598,094

(22) Filed: Mar. 7, 2024

(51) Int. Cl. G06F 9/50

(52) U.S. Cl. CPC G06F 9/5083

(57) ABSTRACT

A computer implemented method for assigning a request in a multi-cluster system. A processor set receives the request for processing by the multi-cluster system. The processor set determines whether a first pod on a node meeting a carbon intensity threshold is available to process the request without a service level agreement violation over a violation threshold. The processor set assigns the request to the first pod on the node meeting the carbon intensity threshold in response to the first pod being available and a service level agreement violation over the violation threshold being absent. The processor set assigns the request to a second pod that does not result in a service level agreement violation over the violation threshold in response to a service level agreement violation being present for assigning the request to the first pod.

### BACKGROUND

The disclosure relates generally to an improved computing system and more specifically to routing requests in a multi-cluster environment.

A multi-cluster system is a distributed computing system that includes multiple clusters of interconnected computers. These computers are referred to as nodes. Each cluster in the multi-cluster system can be organized to handle different workloads or services to provide scalability, fault tolerance, and isolation.

The multi-cluster system can provide a service to users by running multiple instances of the service in one or more of the clusters in a multi-cluster system. Users can access the service in the multi-cluster system by submitting requests. These requests are routed to one of the service instances for the requested service.

Each service instance can run in a pod in a node in the cluster. For example, a cloud environment can have multiple Kubernetes clusters that provide services such as artificial intelligence for machine learning interfacing services to users through a load balancer. The load balancer assigns requests for the service to pods running on nodes in the Kubernetes clusters.

### SUMMARY

According to one illustrative embodiment, a computer implemented method for assigning a request in a multi-cluster system is provided. A processor set receives the request for processing by the multi-cluster system. The processor set determines whether a first pod on a node meeting a carbon intensity threshold is available to process the request without a service level agreement violation over a violation threshold. The processor set assigns the request to the first pod on the node meeting the carbon intensity threshold in response to the first pod being available and a service level agreement violation over the violation threshold being absent. The processor set assigns the request to a second pod that does not result in a service level agreement violation over the violation threshold in response to a service level agreement violation being present for assigning the request to the first pod. According to other illustrative embodiments, a computer system and a computer program product for assigning a request in a multi-cluster system are provided.

### BRIEF DESCRIPTION OF THE DRAWINGS

FIG. 1 is a block diagram of a computing environment in accordance with an illustrative embodiment;

FIG. 2 is a block diagram of a multi-cluster environment in accordance with an illustrative embodiment;

FIG. 3 is a diagram illustrating scheduling pods to clusters in a multi-cluster system in accordance with an illustrative embodiment;

FIG. 4 is a diagram illustrating scheduling pods to nodes in a multi-cluster system in accordance with an illustrative embodiment;

FIG. 5 is a diagram illustrating carbon aware global load balancing for a multi-cluster system in accordance with an illustrative embodiment;

FIG. 6 is a diagram illustrating load balancing using cluster load balancers in accordance with an illustrative embodiment;

FIG. 7 is a diagram illustrating multi-cluster rescheduling in accordance with an illustrative embodiment;

FIG. 8 is a flowchart of a process for multi-cluster carbon aware load balancing in accordance with an illustrative embodiment;

FIG. 9 is a flowchart of a process for carbon aware pod eviction and rescheduling in accordance with an illustrative embodiment;

FIG. 10 is a flowchart of a process for triggering pod eviction in accordance with an illustrative embodiment;

FIG. 11 is a flowchart of a process for determining whether a pod should be considered for carbon aware load balancing of workloads in accordance with an illustrative embodiment;

FIG. 12 is a flowchart of a process for determining whether to explicitly evict a pod in accordance with an illustrative embodiment;

FIG. 13 is a flowchart of a process for assigning a request in a multi-cluster system in accordance with an illustrative embodiment;

FIG. 14 is a flowchart of a process for adjusting a carbon intensity threshold in accordance with an illustrative embodiment;

FIG. 15 is a flowchart of a process for assigning a request cluster in accordance with an illustrative embodiment;

FIG. 16 is a flowchart of a process for identifying usable pods in accordance with an illustrative embodiment;

FIG. 17 is a flowchart of a process for evicting a pod in accordance with an illustrative embodiment;

FIG. 18 is a flowchart of a process for determining the usability of a pod in accordance with an illustrative embodiment;

FIG. 19 is a flowchart of a process for load balancing with usable pods in accordance with an illustrative embodiment;

FIG. 20 is a flowchart of a process for changing pod availability in accordance with an illustrative embodiment;

FIG. 21 is a flowchart of a process for changing resource availability in accordance with an illustrative embodiment;

FIG. 22 is a flowchart of a process for assigning weights to pods in importance with an illustrative embodiment;

FIG. 23 is a flowchart of a process for assigning requests to pods using a load balancing policy in accordance with an illustrative embodiment; and

FIG. 24 is a block diagram of a data processing system in accordance with an illustrative embodiment.

### DETAILED DESCRIPTION

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

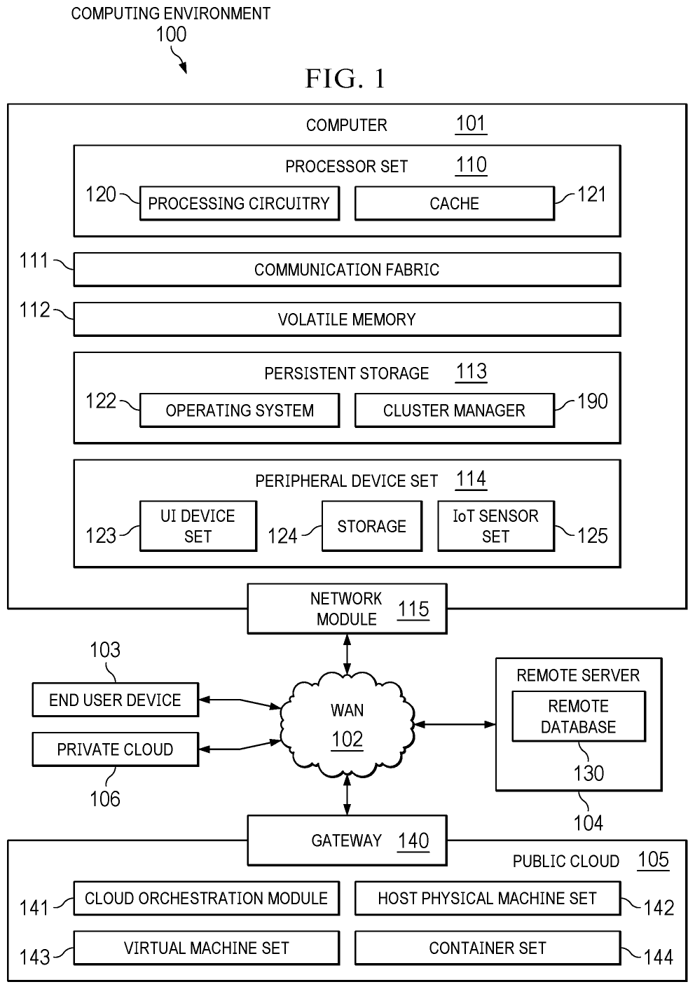

With reference now to the figures in particular with reference to FIG. 1, a block diagram of a computing environment is depicted in accordance with an illustrative embodiment. Computing environment 100 contains an example of an environment for the execution of at least some of the computer code involved in performing the inventive methods, such as cluster manager 190. In addition to cluster manager 190, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and cluster manager 190, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer-readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in cluster manager 190 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in cluster manager 190 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

CLOUD COMPUTING SERVICES AND/OR MICROSERVICES: Public cloud 105 and private cloud 106 are programmed and configured to deliver cloud computing services and/or microservices (not separately shown in FIG. 1). Unless otherwise indicated, the word “microservices” shall be interpreted as inclusive of larger “services” regardless of size. Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to an “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

The illustrative embodiments recognize and take into account one or more different considerations as described herein. Currently, services are not considered in multi-cluster environments in a manner that takes into account carbon emissions. In this illustrative example, carbon emissions refer to the emissions of carbon dioxide. These carbon emissions can also include other greenhouse gases. Carbon emissions can be referred to as carbon intensity (CI).

Carbon emissions can have units that are an amount of carbon dioxide per unit of energy consumed. The units can be an amount of carbon dioxide per unit of energy consumed. For example, carbon emissions can be in grams of carbon per kilowatt hour or grams of carbon per hour of computation.

Services in clusters are not managed by currently used controllers that manage pods such as those for Kubernetes. This type of architecture has a job controller and a deployment controller. These controllers consider jobs and do not service or manage services in a manner that takes into account carbon emissions.

Executing service instances for services to provide a service to users consumes power over time. This use of power results in a carbon footprint. In servicing requests for a service, it is desirable to find a pod for a service instance among the different service instances running on other pods in the multi-cluster system that reduces the total carbon footprint as well as meeting other objectives. For example, when two requests are received at the same time, a first request for floating point multiplication can be routed to a digital calculator service instance hosted on a node with low carbon emission. The second request for integer multiplication can be routed to a calculator service instance hosted on a node with high carbon emission. In this example, the labels of high carbon emission and low carbon emission refer to categories that are assigned to nodes based on carbon emissions from nodes. This type of routing is based on an assumption that floating point multiplication uses more processor cycles than integer multiplication. As a result, the request for floating-point multiplication is directed to a pod on a node with a lower level of carbon emissions. These carbon emissions can also be referred to as carbon intensity (CI).

Further, the rescheduling of pods corresponding to service can be performed in multi-cluster systems. The routing requests to pods for responding to a service in the carbon aware manner is also not considered with current multi-cluster systems. In other words, services provided by the pods are not considered when rescheduling these pods.

Thus, the illustrative examples provide a computer implemented method, apparatus, system, and computer program product for managing requests in a multi-cluster system. In managing routing of requests in an illustrative example, whether a first pod on a node meeting a carbon intensity threshold is available to process the request without a service level agreement violation over a violation threshold can be determined for a request received for assignment to a pod. The request is assigned to the first pod on the node meeting the carbon intensity threshold in response to the first pod being available and a service level agreement violation over the violation threshold being absent. The request is assigned to a second pod that does not result in a service level agreement violation over the violation threshold in response to a service level agreement violation being present for assigning the request to the first pod. In these examples, the service level agreement is for a service requested by the requests.

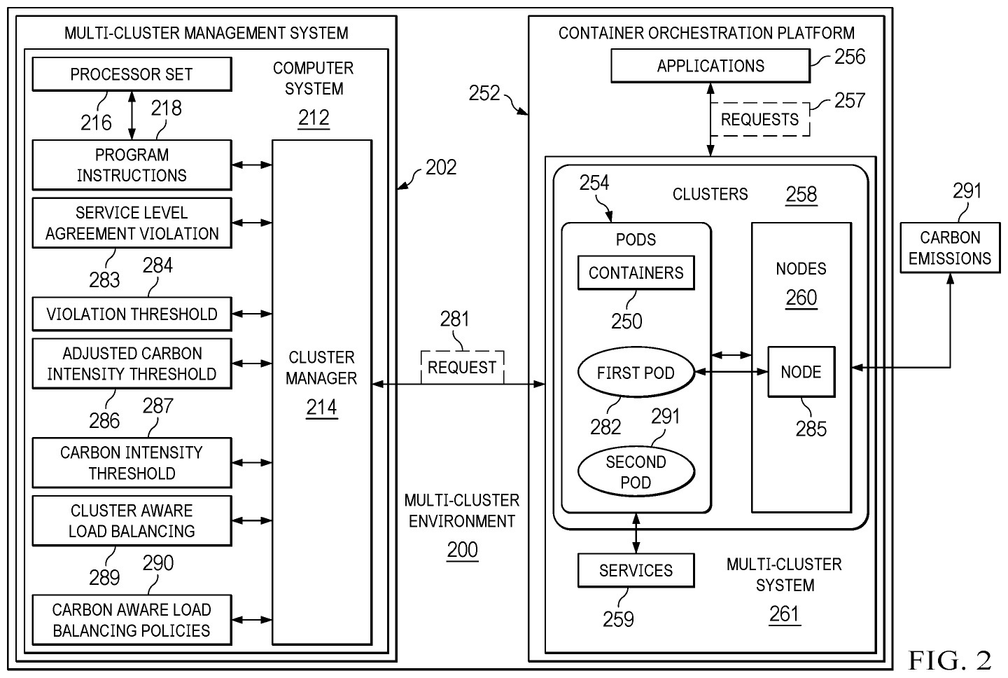

With reference now to FIG. 2, a block diagram of a multi-cluster environment is depicted in accordance with an illustrative embodiment. In this illustrative example, multi-cluster environment 200 includes components that can be implemented in hardware such as the hardware shown in computing environment 100 in FIG. 1. In this example, multi-cluster management system 202 can operate to manage processing of requests 257 by multi-cluster system 261 in container orchestration platform 252.

Container orchestration platform 252 can be, for example, a Kubernetes® architecture, environment, or the like. However, it should be understood that descriptions of illustrative examples using Kubernetes is meant as an example architecture only and not as a limitation on illustrative embodiments. Container orchestration platform 252 can also be referred to as a container orchestration system.

In this example, multi-cluster system 261 comprises clusters 258. Further, in this example, clusters 258 comprise pods 254 that run on nodes 215. Each pod in pods 254 can run workloads to process requests 257 received from applications 256 for services 259.

In this example, pods 254 are for services 259. Each pod in pods 254 can run an instance of a service in services 259. While the term “pod” is generally used in the Kubernetes paradigm, the term as used herein is not limited to that environment but rather refers to any grouping of a number of containers 250 where workloads are deployed and hold the running applications, libraries, and their dependencies.

In these examples, the workloads can be run by containers 250 in pods 254. A container is a standard unit of software for an application that packages up program instructions and all its dependencies, so the application can run on multiple computing environments. A container isolates software from the environment in which the container runs and ensures that the container works uniformly in different environments. A container for an application can share the operating system kernel on a machine with other containers for other applications. As a result, an operating system is not required for each container running on the machine.

In this illustrative example, multi-cluster management system 202 comprises computer system 212 and cluster manager 214. In this example, cluster manager 214 is located in computer system 212. Cluster manager 214 may be implemented using cluster manager 190 in FIG. 1.

Cluster manager 214 can be implemented in software, hardware, firmware, or a combination thereof. When software is used, the operations performed by cluster manager 214 can be implemented in program instructions configured to run on hardware, such as a processor unit. When firmware is used, the operations performed by cluster manager 214 can be implemented in program instructions and data and stored in persistent memory to run on a processor unit. When hardware is employed, the hardware can include circuits that operate to perform the operations in cluster manager 214.

In the illustrative examples, the hardware can take a form selected from at least one of a circuit system, an integrated circuit, an application-specific integrated circuit (ASIC), a programmable logic device, or some other suitable type of hardware configured to perform a number of operations. With a programmable logic device, the device can be configured to perform the number of operations. The device can be reconfigured at a later time or can be permanently configured to perform the number of operations. Programmable logic devices include, for example, a programmable logic array, a programmable array logic, a field-programmable logic array, a field-programmable gate array, and other suitable hardware devices. Additionally, the processes can be implemented in organic components integrated with inorganic components and can be comprised entirely of organic components excluding a human being. For example, the processes can be implemented as circuits in organic semiconductors.

As used herein, “a number of” when used with reference to items, means one or more items. For example, “a number of operations” is one or more operations.

Further, the phrase “at least one of,” when used with a list of items, means different combinations of one or more of the listed items can be used, and only one of each item in the list may be needed. In other words, “at least one of” means any combination of items and number of items may be used from the list, but not all of the items in the list are required. The item can be a particular object, a thing, or a category.

For example, without limitation, “at least one of item A, item B, or item C” may include item A, item A and item B, or item B. This example also may include item A, item B, and item C or item B and item C. Of course, any combination of these items can be present. In some illustrative examples, “at least one of” can be, for example, without limitation, two of item A; one of item B; and ten of item C; four of item B and seven of item C; or other suitable combinations.

Computer system 212 is a physical hardware system and includes one or more data processing systems. When more than one data processing system is present in computer system 212, those data processing systems are in communication with each other using a communications medium. The communications medium can be a network. The data processing systems can be selected from at least one of a computer, a server computer, a tablet computer, or some other suitable data processing system.

As depicted, computer system 212 includes processor set 216 that is capable of executing program instructions 218 implementing processes in the illustrative examples. In other words, program instructions 218 are computer-readable program instructions. Processor set 216 is an example of processor set 110 in FIG. 1.

As used herein, a processor unit in processor set 216 is a hardware device and is comprised of hardware circuits such as those on an integrated circuit that respond to and process instructions and program code that operate a computer. Processor set 216 can be a number of processor units and can be implemented using processor set 110 in FIG. 1. The processor units can also be referred to as computer processors. When processor set 216 executes program instructions 218 for a process, processor set 216 can be one or more processor units that are in the same computer or in different computers. In other words, the process can be distributed between processor units in processor set 216 on the same or different computers in computer system 212.

Further, processor set 216 can include the same type or different types of processor units. For example, processor set 216 can be selected from at least one of a single core processor, a dual-core processor, a multi-processor core, a general-purpose central processing unit (CPU), a graphics processing unit (GPU), a digital signal processor (DSP), or some other type of processor unit.

Although not shown, processor set 216 can also include other components in addition to the processor units or processing circuitry. For example, processor set 216 can also include a cache or other components used with processor units or other processing circuitry.

In this illustrative example, cluster manager 214 performs cluster carbon aware load balancing 289 using a set of carbon aware load balancing policies 290. Currently available load balancing policies can be implemented with modifications to take into account carbon emissions 291 generated by nodes 260 in a manner that reduces carbon emissions 291 when processing requests 257 using pods 254. Carbon aware load balancing policies 290 can take a number of different forms. For example, carbon aware load balancing policies 290 can be policies such as round robin, ring hash, maglev and others can be used with modifications made to take into account carbon emissions 291.

In performing cluster carbon aware load balancing 289, cluster manager 214 can perform at least one of global load balancing for clusters 263 or cluster load balancing for individual clusters in clusters 263 for requests 257 received by multi-cluster system 261. In this example, global load balancing involves routing requests to be said to different clusters in clusters 258. Cluster load-balancing involves routing requests received at a cluster to different pods running on nodes in the cluster. In this example, the load-balancing involves reducing carbon emissions and meeting service level agreements.

Cluster manager 214 can include load balancing processes or control load balancing processes. For example, in load balancing requests 257, cluster manager 214 assigns requests 257 to pods running on nodes 260 in clusters 263. This assignment of the requests 257 can be made using carbon aware load balancing policies 290.

In one illustrative example, cluster manager 214 receives request 281 for processing by multi-cluster system 261. Cluster manager 214 determines whether first pod 282 on node 285 meeting carbon intensity threshold 287 is available to process request 281 without service level agreement violation 283 over violation threshold 284.

With this determination, first pod 282 can be considered available when an absence of service level agreement violation 283 is present. Further, first pod 282 can also be considered available if service level agreement violation 283 is present but not over violation threshold 284.

In this illustrative example, the service level agreement defines a number of metrics that need to be met. If these number of metrics are not met, a service level agreement violation 283 occurs. Additionally, violation threshold 284 is present in this example.

In this example, carbon intensity threshold 287 defines a level of carbon emissions. This level carbon emissions can be for nodes in clusters 263. This threshold can identify a maximum level of carbon emissions that are acceptable for routing pods to nodes. In this example, node 285 meets carbon intensity threshold 287 having a carbon emissions level that is equal to or less than the level defined by carbon intensity threshold 287.

The number of metrics defined in the service level agreement can take a number of different forms. For example, the number of metrics can be one or more of response time, uptime, availability, throughput, scalability, latency, regulatory standard compliance, or some other metric.

Exceeding one or more of the number of metrics set by the service level agreement results in a service level agreement violation 283. This type of violation may result in a notification or warning that enables taking corrective actions to reduce or prevent further violations. Exceeding violation threshold 284 may result in more severe consequences. For example, penalties, service credits, and changes in load balancing policies may occur.

For example, a metric in the service level agreement can be response time. The service level agreement can set 20 ms as a response time. If the response time is over 20 ms, then service level agreement violation 283 is present. With this type of violation, changes in load balancing and resource allocation can be made to reduce response times response to receiving a notification or warning that service level agreement violation 283 has occurred.

With this example, violation threshold 284 can be set at 35 ms. In this example, service level agreement violation 283 of up to 35 ms is acceptable. If the response time exceeds 30 ms, then violation threshold 283 has been exceeded. In this case, a number of penalties, consequences, or other actions may occur.

In one illustrative example, cluster manager 214 assigns request 281 to first pod 282 on node 285 meeting carbon intensity threshold 287 in response to first pod 282 being available and service level agreement violation 283 over violation threshold 284 being absent.

In this example, cluster manager 214 assigns request 281 to second pod 291 in pods 254 that does not result in a service level agreement violation 283 over violation threshold 284 in response to service level agreement violation 283 over violation threshold 284 being present for assigning request 281 to first pod 282.

Further, cluster manager 214 can also manage pods 254. For example, cluster manager 214 can schedule pods 254 on nodes 260 in clusters 258 in a manner that takes into account carbon emissions generated by nodes 260 when using pods 254 to process requests 257. In this example, the scheduling of pods 254 involves finding nodes 260 to place pods 254 in a manner that takes into account carbon emissions 291 and reducing service level agreement violations when processing requests 257 for services 259.

Computer system 212 can be configured to perform at least one of the steps, operations, or actions described in the different illustrative examples using software, hardware, firmware, or a combination thereof. As a result, computer system 212 operates as a special purpose computer system in which cluster manager 214 in computer system 212 enables managing the processing of requests in a multi-cluster system in a manner that is carbon aware. For example, requests can be routed to different pods on different nodes based on carbon emissions for the nodes on which pods run. Additionally, the use and placement of pods can be managed in a manner that reduces carbon emissions. For example, pods can be placed on nodes with desired levels of carbon emissions. Further, pods can be evicted and rescheduled if changes to carbon emissions on the nodes on which those pods run increase to undesired levels. These carbon emissions can be taken into account when routing requests to meet service level agreements.

The illustration of multi-cluster environment 200 in FIG. 2 is not meant to imply physical or architectural limitations to the manner in which an illustrative embodiment can be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment.

For example, computer system 212 and cluster manager 214 are shown as separate components from multi-cluster system 261 in container orchestration platform 252. In one illustrative example, cluster manager 214 in computer system 212 can be components within container orchestration platform 252 and may be part of multi-cluster system 261. Further, load balancing processes in cluster manager 214 can be in the form of distributed processes located in one or more computers within multi-cluster system 261.

As another example, the scheduling of pods to running clusters can be performed with two levels of scheduling. A first level scheduling is performed to assign pods to clusters. After pods have been assigned to clusters, a second level scheduling is performed to assign pods to nodes in a cluster. In this example, the scheduling is performed taking into account carbon emissions generated by nodes. The scheduling is performed to meet service level agreements for services and to take into account carbon emissions in processing requests for the services.

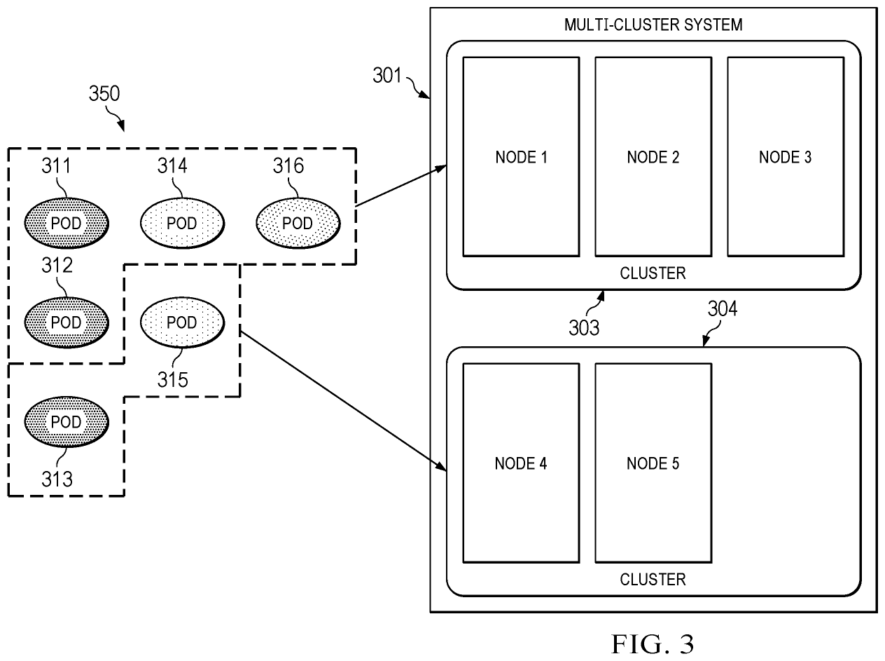

With reference next to FIG. 3, a diagram illustrating scheduling pods to clusters in a multi-cluster system is depicted in accordance with an illustrative embodiment. In the illustrative examples, the same reference numeral may be used in more than one figure. This reuse of a reference numeral in different figures represents the same element in the different figures.

As depicted, first level scheduling can be performed to assign these pods 350 in multi-cluster system 301. In this illustrative example, multi-cluster system 301 is an example of multi-cluster system 261 in FIG. 2. As depicted, multi-cluster system 301 comprises cluster 303 and cluster 304. Cluster 303 contains Node 1, Node 2, and Node 3. Cluster 304 contains Node 4 and Node 5. Pods 350 comprises pod 311, pod 312, pod 313, pod 314, pod 315, and pod 316. In this example, pod 311, pod 312, and pod 313 run instances of a first service; pod 314; pod 315 run an instance of a second service; and pod 316 runs an instance of a third service.

The scheduling of pods 350 can be performed by a controller such as cluster manager 214 in FIG. 2. In this example, the scheduling of pods 350 is performed with two levels of scheduling. Pods 350 are first scheduled for placement into one of cluster 303 and cluster 304. For example, pod 311, pod 312, pod 314 and pod 316 can be assigned to cluster 303. Further, pod 313 and pod 315 can be assigned to cluster 304.

In this example, the assignment of pods 350 to the clusters takes into account workloads and carbon emissions from the clusters. Workloads performed by the clusters and the average emissions from nodes in the clusters can be used in assigning pods 350 to cluster 303 and cluster 304.

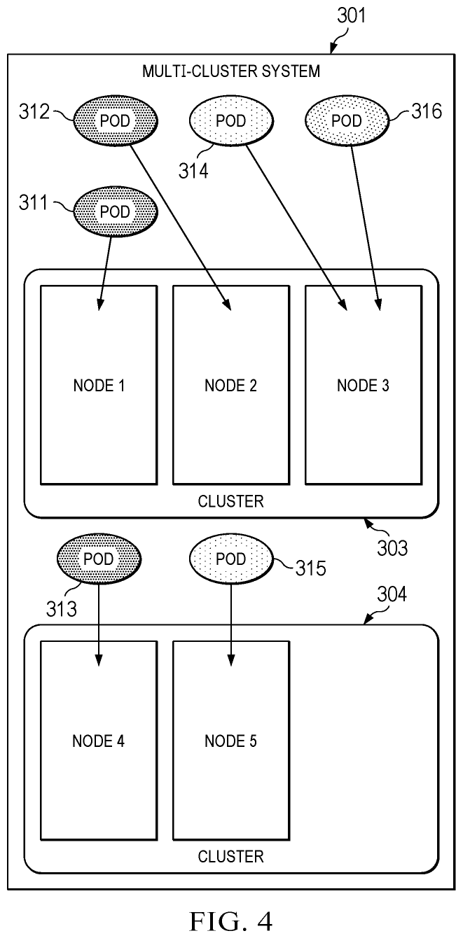

Turning to FIG. 4, a diagram illustrating scheduling pods to nodes in a multi-cluster system is depicted in accordance with an illustrative embodiment. In this example, pod 311, pod 312, pod 314 and pod 316 have been assigned to cluster 303. Pod 313 and pod 315 have been assigned to cluster 304.

Further, in this example, second level scheduling can be performed at the cluster level to assign pod 311, pod 312, pod 314 and pod 316 to Node 1, Node 2, or Node 3 in cluster 303. For example, pod 311 can be assigned to Node 1, and pod 312 can be assigned to Node 2. Pod 314 and pod 316 can be assigned to Node 3. This scheduling can also assign pod 313 and pod 315 to Node 4 or Node 5 in cluster 304.

In this example, the scheduling of pods into nodes takes into account meeting service level agreements and carbon emissions. Pods can be scheduled on nodes based on the carbon emissions generated by the nodes. A preference can be given to nodes with lower carbon emissions. For example, more pods may be scheduled on nodes with lower emissions than pods with higher emissions.

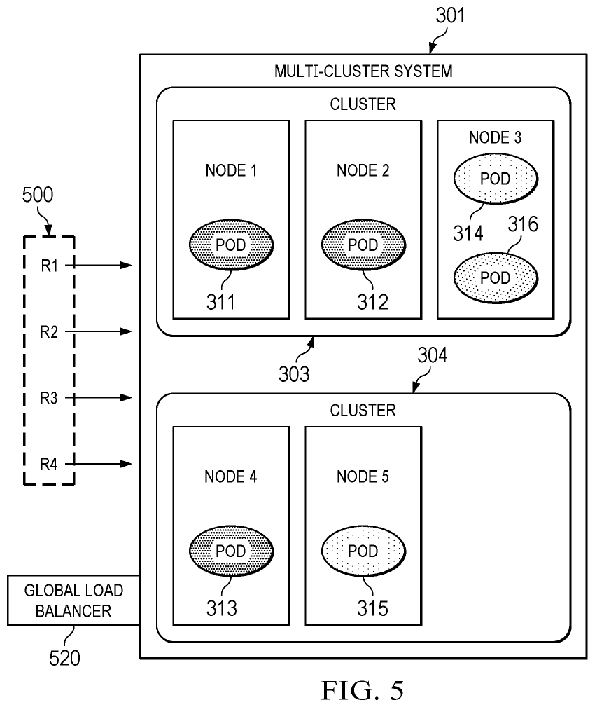

With reference next to FIG. 5, a diagram illustrating a carbon aware global load balancer for a multi-cluster system is depicted in accordance with an illustrative embodiment. In this illustrative example, requests 500 are received from users at multi-cluster system 301 for a service in multi-cluster system 301. In this example, requests 500 include request R1, request R2, request R3 and request R4.

As depicted, pod 311 on Node 1 in cluster 303, pod 312 on Node 2 in cluster 303, and pod 313 on Node 4 in cluster 304 are pods that handle requests 500 for the service. The pod 314 in Node 3, pod 316 in Node 3, and pod 315 in Node 5 handle requests for other services in this example.

In this illustrative example, global load balancer 520 is a carbon aware global load balancer and can route requests to cluster 303 and cluster 304 in a manner that takes into account reducing carbon emissions from multi-cluster system 301. Global load balancer 520 can be implemented in cluster manager 214 in FIG. 2.

In this example, global load balancer 520 sends request R1, request R2, and request R3 to cluster 303. Request R4 is sent by global load balancer 520 to cluster 304.

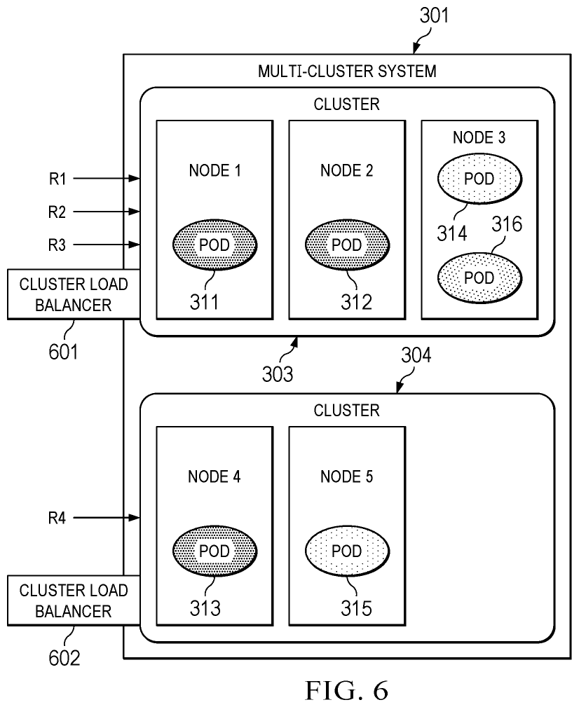

Next in FIG. 6, a diagram illustrating load balancing using cluster load balancers is depicted in accordance with an illustrative embodiment. In this illustrative example, cluster load balancer 601 handles routing requests received for cluster 303 and cluster load balancer 602 handles routing of requests received for cluster 304. These cluster load balancers can be implemented in cluster manager 214 in FIG. 2.

For example, cluster load balancer 601 selects one or both of pod 311 and pod 312 to process request R1, request R2, and request R3 requests. These two pods run instances of the service requested by these requests. Further, the particular pods from pod 311 and pod 312 are selected depending on whether service level agreement violations would occur and take into account carbon emissions from the nodes.

In this example, cluster load balancer 602 routes requests R4 to pod 313 in Node 4. Pod 313 is the only pod that can service this type of request in cluster 304.

As part of routing requests, at least one of horizontal pod scaling (HPA) or vertical pod scaling (VPA) can be used. This type is performed to reduce service level agreement violations and is performed to reduce carbon emissions. For example, horizontal pods auto scaling can be performed to add an additional pod to Node 1 in cluster 304 if using pod 313 would result in a service level agreement violation. In another example, vertical pod auto scaling can add resources to pod 313 to reduce or avoid service level agreement violations.

Thus, the load balancing performed by global load balancer 520 in FIG. 5 and cluster load balancer 601 in FIG. 6 and cluster load balancer 602 in FIG. 6 illustrates a two-tier load balancing within multi-cluster system 301. The stipend load balancing can reduce issues with service level agreement violations and reduce carbon emissions through carbon aware load balancing. These load balancers can be carbon load balancers and can be enabled to use both vertical pod autoscaling and horizontal pod autoscaling.

In one example, pod 311, pod 312, and pod 313 are pods that handle requests 350. In this example the carbon emissions are 100 for Node 1, 120 for Node 2 and 140 for Node 4. In this example, if the carbon intensity (CI) threshold is 110, then only the Pod on Node 1 can be used for servicing the incoming requests (pods on Node 2 and Node 4 are not used).

Workload service level agreement violations can be present even with load balancing. For example, an SLA violation can be present with a high incoming request rate even though the workload SLA is not sensitive. In another example, the workload SLA can occur with a moderate incoming request rate and the workload SLAs are sensitive. In another example, incoming request rate is high and workload SLAs are sensitive.

In these situations, carbon intensity threshold can be increased such that more pods are available to service the incoming requests. For example, the carbon intensity threshold may change from 110 to 130. With this change, both the pods on Node 1 and Node 2 become available for servicing the incoming requests. With this example, pod 313 on Node 4 is not used. With an increase in the carbon intensity threshold, the same number of incoming requests can be serviced without workload SLA violations or a reduced number of workload SLA violations.

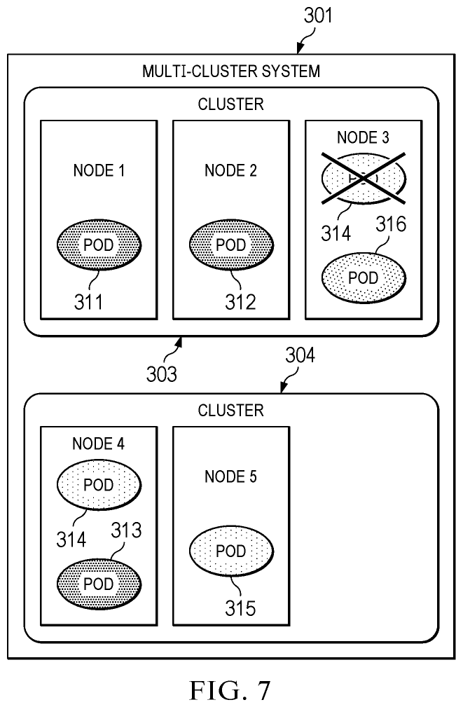

Next in FIG. 7, a diagram illustrating multi-cluster rescheduling is depicted in accordance with an illustrative embodiment. The different steps illustrated in this figure can be performed using cluster manager 214 in FIG. 2. In this example, explicit eviction of a pod can occur in which a pod is removed or terminated based on a condition or rule. In this example, the eviction can be performed based on a change in carbon emissions for a node. A scheduler process in a cluster manager can place the evicted pods on different nodes to perform rescheduling.

In this example, different nodes in cluster 303 and cluster 304 can be deployed in different zones. These different zones are in different geographic regions that have diverse energy sources resulting in different carbon emissions for the nodes in the different zones.

In this illustrative example, Node 3 is deployed in the zone with high emissions as compared to the other nodes in multi-cluster system. Further in this example, pod 314 is evicted from Node 3. This pod can be evicted because Node 3 is deployed in a zone with high emissions.

Further, rescheduling of pod 314 can be performed to determine whether an alternative placement can be found that provides for running pod 314 on another node with lower emissions that meets a carbon emission threshold. The actual eviction of pod 314 can be triggered in response to finding an alternative placement for pod 314 on a node that enables running pod 314 with lower carbon emissions compared to Node 3.

In this illustrative example, Node 4 has a lower level of emissions than Node 3. As a result, pod 314 is evicted and rescheduled to run on Node 4. In this example, the rescheduling results in the movement of pod 314 from Node 3 to Node 4.

In some cases, some of the pods may remain unscheduled because nodes are unsuitable or the evicted pods are unavailable. For example, a pod may remain unscheduled because of scarcity of resources in the same cluster. With this situation, the pod can be rescheduled in a different cluster.

Further, the pod specification can be updated to avoid undesired consolidation during cluster autoscaling when cluster autoscaling is present. Cluster autoscaling can change the number of nodes that are available. When cluster autoscaling is used, pod eviction may result in instances in which pods on nodes with low carbon emissions need to be moved to nodes on high carbon emissions. In this illustrative example, the use of the terms “low” and “high” with respect to carbon emissions can refer to categories of carbon emissions in which high carbon emissions are higher than low carbon emissions.

For example, explicitly evicting a pod from a first node which has high carbon emissions can result in freeing up or releasing CPU and memory resources on that first node. In this example, other pods are running on other nodes. In this example, a second pod runs on a second node with low carbon emissions. If the resources on the first node are sufficient to move the second pod running on the second node, the second pod may be moved to the first node from the second node. In this case, the second node may be removed from the cluster, resulting in the removal of a node with low carbon emissions.

This type of cluster autoscaling consolidation results in an increase in carbon emissions. To prevent the removal of nodes with low carbon emissions during consolidation and cluster autoscaling, a PodDisruptionBudget is set for pods running on such nodes. This is a parameter in Kubernetes that defines the minimum number of pods that must remain available during the disruption. This parameter can be used to maintain the availability of pods such that the removal of low carbon emission nodes may be reduced.

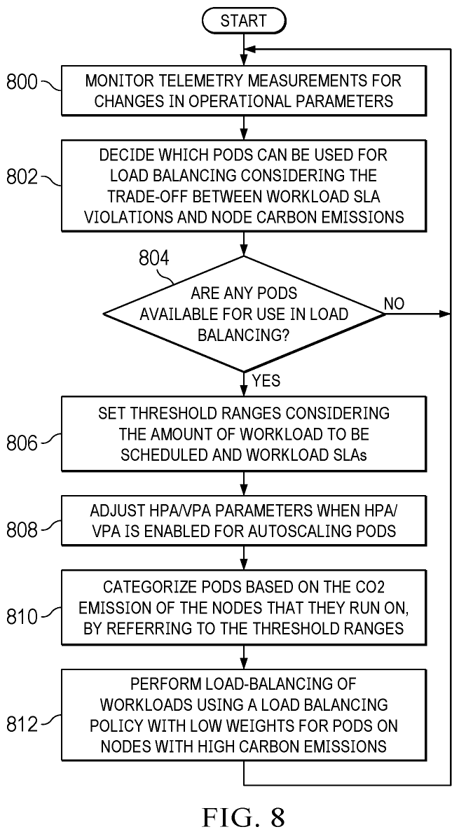

Turning next to FIG. 8, a flowchart of a process for multi-cluster carbon aware load balancing is depicted in accordance with an illustrative embodiment. The process in FIG. 8 can be implemented in hardware, software, or both. When implemented in software, the process can take the form of program instructions that are run by a processor set located in one or more hardware devices in one or more computer systems. For example, the process can be implemented in cluster manager 214 in computer system 212 in FIG. 2.

The process begins by monitoring telemetry measurements for changes in operational parameters (step 800). In step 800, operational parameters can be identified from telemetry measurements such as logs, metrics, traces, carbon emissions for cluster nodes collected as part of multi-cluster observability. The operational parameters of interest can be ones that relate to changes in sustainability. For example, changes in carbon emissions can occur in a multi node cluster.

The process decides which pods can be used for load balancing considering the trade-off between workload SLA violations and node carbon emissions (step 802). A determination is made as to whether any pods are available for use in load balancing (step 804). In step 804, these pods can also be referred to as usable pods. If pods are not available for load balancing, the process returns to step 800.

Otherwise, the process sets threshold ranges for nodes considering the amount of workload to be scheduled and workload SLAs (step 806). In step 806, these ranges can then be used to categorize and assign weights to the pods. For example, a range of 110 to 120 can be high, a range of 100 to 119 can be medium, a range of 50-99 can be low. With this example, 120 can be a threshold range over which a pod on a node exceeding this value is not used for load balancing. This threshold is an example of a carbon intensity threshold.

The process adjusts HPA and VPA parameters when HPA and VPA are enabled for autoscaling pods (step 808). In this step, the parameters are set to provide carbon aware scaling.

With horizontal pod autoscaling, the number of pods can be scaled up or down in response to increases and decreases in workloads taking into account carbon emissions. Parameters are set for horizontal pod autoscaling (HPA) to perform load balancing that optimizes carbon emissions.

As an example, a target utilization for resources is set to 50% in the HPA configuration. In this illustrative example, two pods are present for a service and the maximum number of pods for the service is ten. In this example, each instance of the service is run on a single pod.

The first pod runs on a first node that is above the carbon intensity threshold and second pod runs a second node below the carbon intensity threshold. Further, the resources of the second node are fully allocated in this example. Also in this example, the current load is such that the utilization of resources is below 50% across the two pods.

If incoming requests are sent to the second pod running on the second node, then an increase in the current load can result in horizontal pod autoscaling that increases the number of pods running instances for the service to three by starting a new pod on the first node that has carbon emissions above the carbon intensity threshold.

In this illustrative example, it may be possible to complete the current workload without service-level agreement violations and without the need for spinning up a new pod on a first node with carbon emissions above carbon intensity threshold. In this example, the situation can be avoided by increasing the target utilization for resources from 50% to 80%, as part of custom load balancing. In another example, a new pod may not be spun up even if service-level agreement violations occur when the overhead is less.

Vertical pod autoscaling (VPA) can be used to change resources allocated to pods in response to an increase or decrease in workloads. Resources can be increased or decreased depending on the change in workloads. Vertical pod autoscaling parameters can be set by the load balancer to optimize carbon emissions.

As an example, two pods run on two nodes as instances for a service. The first pod runs on a first node that has carbon emissions above the carbon intensity threshold. The second pod runs on a second node that has carbon emissions below the carbon intensity threshold. Further, in this example, the resources of the second node are fully allocated.

As the carbon aware load balancer sends incoming requests to both these pods, if the incoming request rate is high, the vertical pod autoscaling may recommend a high number of resources as the target resource allocation for these pods. The resources may be recommended from an allowed range [lower bound, upper bound] of vertical pod autoscaling parameters.

Subsequently, vertical pod autoscaling evicts the first pod from the first node and re-creates the first pod with an increased resources (as per the vertical pod autoscaling recommendation) on the first node. In this example, this vertical pod autoscaling results in the second pod being evicted from the second node. This second pod, however, cannot be re-created on the second node because insufficient resources are present on the second node. As a result, the second pod is recreated on the first node. This re-recreating of the second pod on the first node results in higher carbon emissions for the execution of these pods, which is undesired result from vertical pod autoscaling.

Not using vertical pod autoscaling target resource recommendations may result in workload service-level agreement violations. However, the carbon-aware load balancer may overwrite the vertical pod autoscaling target resource recommendations to avoid an increase in carbon emissions if the overhead due to possible service-level agreement violations are less.

The process categorizes pods based on the carbon emissions of the nodes that the pods run on using the threshold ranges (step 810). In step 810, the categories assigned to the pods can be based on ranges set in step 806. For example, if three threshold ranges are present, the categories can be low, medium, and high. In another example, if five threshold ranges are present, the categories can be numerical such as 1, 2, 3, 4, and 5.

The process then performs load balancing of workloads using a load balancing policy with low weights for pods on nodes with high carbon emissions (step 812). In step 812, different policies for load balancing can include round-robin, leased connections, leased response time, random selection, lease seeking new usage and other types of load balancing policies. In these examples, these load balancing policies can be modified to be carbon aware such that the selection of pods are influenced by carbon emissions by which the pods are located. The process then returns to step 800.

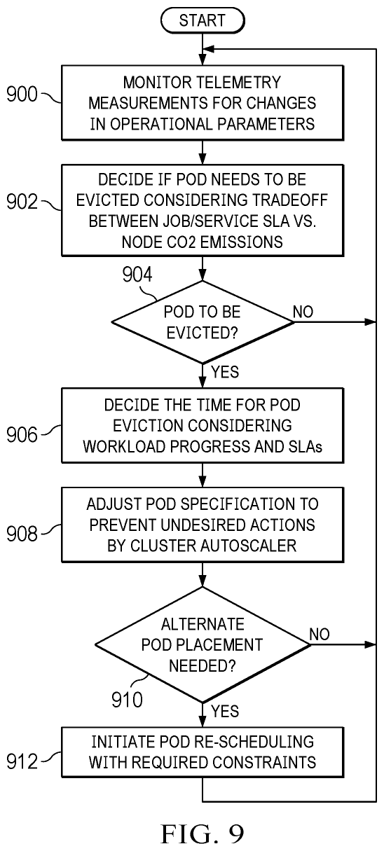

With reference to FIG. 9, a flowchart of a process for carbon aware pod eviction and rescheduling is depicted in accordance with an illustrative embodiment. The process in FIG. 9 can be implemented in hardware, software, or both. When implemented in software, the process can take the form of program instructions that are run by a processor set located in one or more hardware devices in one or more computer systems. For example, the process can be implemented in cluster manager 214 in computer system 212 in FIG. 2. This process can be run for each pod on a node in a multi-cluster system.

The process begins by monitoring telemetry measurements for changes in operational parameters (step 900). The process decides whether a pod needs to be evicted considering the trade-off between job and service SLA and node carbon emissions (step 902). In this example, a service is a long-running process while a job is a shorter process relative to the service. A workload can be a task within a job. Different service-level agreements can cover a service or job in which different rules or specifications are present.

A determination is made as to whether the decision is to evict the pod (step 904). If the pod is not to be evicted, the process returns to step 900. Otherwise, the process decides a time for pod eviction upon considering work progress and SLAs (step 906). In step 906, a pod may need to wait for the completion of a subset of ongoing workloads (like ML inferencing tasks) with high SLA violations before getting evicted by terminating a different subset of workloads with low SLA violations that may be retried on a different pod.

The process adjusts the pod specification to prevent undesired actions by the cluster autoscaler (step 908). In step 908, the undesired actions can be an undesired consolidation of pods resulting in pods being located on higher emission nodes. In other words, changes can be made to avoid moving a pod from a lower emission node to a higher emission node as part of the consolidation process.

The process then determines whether an alternate pod placement is needed (step 910). In step 910, different options for placing a pod that is evicted can be made instead of evicting the pod. These options can include considering nodes in the same cluster or different clusters based upon the workloads and carbon emissions within the multi-cluster system. For example, if the pod cannot run on the cluster with a desired level of carbon emissions, that pod can be placed on a different node in the cluster. This placement is an alternate placement that can be considered if the pod is needed to process workloads.

If an alternate pod placement is needed, rescheduling is initiated with required constraints in an appropriate time (step 912). In step 912, rescheduling can be initiated at a time that is selected based on various factors. For example, if current pods are sufficient to handle workloads without service-level agreement violations, pilot rescheduling can be delayed until the evicted pod is needed. Required constraints can include constraints upon processor resource usage. Another example of a required constraint can be avoiding rescheduling an evicted pod on the same cluster. These types of constraints can be implemented as rules for the scheduler that forms pod rescheduling. Another example of required constraint can include retaining existing pod placements in the clusters.

The process then returns to step 900. The process also returns to step 900 from step 910 if an alternate pod placement is not needed.

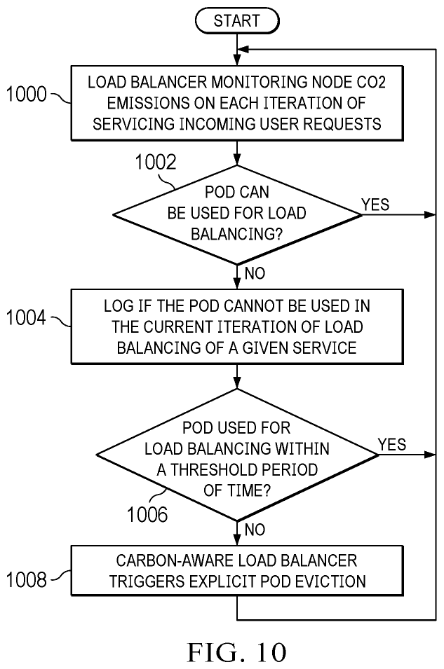

Turning now to FIG. 10, a flowchart of a process for triggering pod eviction is depicted in accordance with an illustrative embodiment. The process in FIG. 10 can be implemented in hardware, software, or both. When implemented in software, the process can take the form of program instructions that are run by a processor set located in one or more hardware devices in one or more computer systems. For example, the process can be implemented in cluster manager 214 in computer system 212 in FIG. 2. In this example, pod eviction is explicit through evicting the pod based on one or more policies. In this example, the policies are carbon aware policies that reduce carbon emissions in a multi-cluster system.

The process monitors node carbon emissions on each iteration of servicing of incoming requests (step 1000). A determination is made as to whether the pod can be used for load balancing (step 1002).

The process generates a log entry if the pod cannot be used in the current iteration for load balancing of a given service (step 1004). In this example, the log entry includes the identification of the pod and the node on which the pod is located. Further, the log entry can also include information used to track iterations in which pods are used to process requests. This information can include, for example, a timestamp, an iteration identifier, or other information.

A determination is made as to whether the pod has been used for load balancing within a threshold period of time (step 1006). In step 1006, this threshold period of time can be selected in a number of different ways. In one illustrative example, the value of the threshold period of time can be chosen based on the lifetime of the pods.

For example, if pods are long running, then the value for the threshold period of time may be in the order of a few minutes to hours. In another example, the value for the threshold period of time can be selected based on the resource pressure on the nodes. For example, if node resource utilization is very high, then the value for the threshold period of time may be in the order of a few seconds to minutes.

If the pod has been used for load balancing within the threshold period of time, the process returns to step 1000. If the pod has not been used for load balancing within the threshold period of time, explicit pod eviction is triggered (step 1008). The process then returns to step 1000.

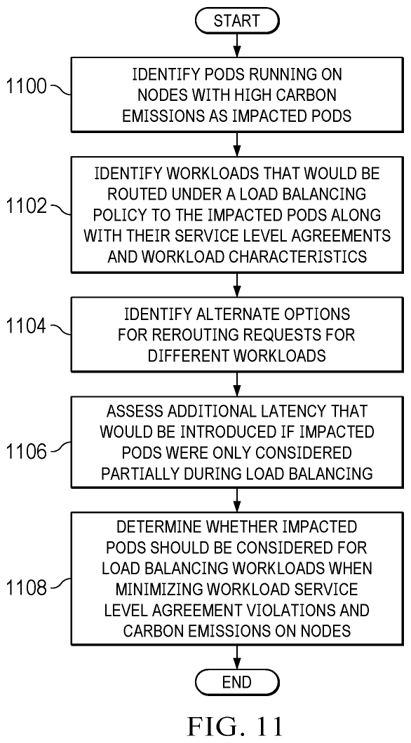

With reference next to FIG. 11, a flowchart of a process for determining whether a pod should be considered for carbon aware load balancing of workloads is depicted in accordance with an illustrative embodiment. This process is an example of steps that can be used to analyze the tradeoff between service level agreement violations and node carbon emissions to decide if pods deployed on nodes with high carbon emissions need to be considered during carbon aware load balancing. The process in this figure is an example of an implementation for step 802 in FIG. 8.

The process begins by identifying pods running on nodes with high carbon emissions as impacted pods (step 1100). In step 1100, high carbon emissions can be nodes that are categorized to have the highest emissions. For example, categories can be low, medium, and high for the carbon emissions in which the high category is for nodes with high carbon emissions. Nodes are placed in these categories based on ranges of emission levels. Each category can have a different range of emissions.

In one illustrative example, a range of 110 to 120 is high, a range of 100 to 109 is medium, and a range of 50-99 is low. These ranges can also be used to categorize pods running on the nodes.

The process identifies workloads that would be routed under a load balancing policy to the impacted pods along with their service level agreements and workload characteristics (step 1102). The process identifies alternate options for rerouting requests for different workloads (step 1104). These options can include pods that can be available for routing workloads.

The process assesses additional latency that would be introduced if impacted pods were only considered partially during load balancing (step 1106). In this example, the pods are running on nodes with carbon emissions that are greater than the threshold level. If all of those pods are excluded from load balancing, then workload service level agreement violations may occur. On the other hand, if all these impacted pods are included, then the carbon emissions may be very high. Another option involves including a subset of these impacted pods for load balancing. When a subset of the impacted pods is used, the pods are considered partially.

The process determines whether impacted pods should be considered for load balancing workloads when minimizing workload service level agreement violations and carbon emissions on nodes (step 1108). The process terminates thereafter. For example, with two pod replicas for a service, pod 1 runs on a first node with high carbon emissions and pod 2 runs on a second node with low emissions. If two requests are received from clients that result in low service level agreement violation costs, then pod 1 may not be considered for load balancing, even if there may be potential additional latency to complete these requests. As another example, two requests are received from clients with high service level agreement violation costs. In this case, both pods are considered for load balancing.

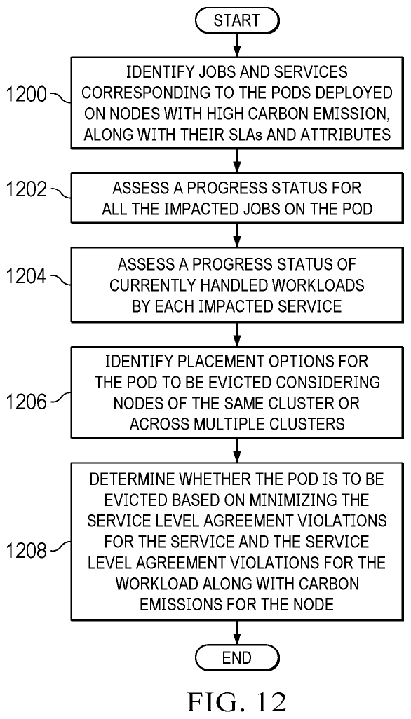

With reference now to FIG. 12, a flowchart of a process for determining whether to explicitly evict the pod is depicted in accordance with an illustrative embodiment. This process is an example of steps that can be used to implement step 902 and step 904 in FIG. 9. This process can be used to determine whether pods on nodes with high carbon emission need to be explicitly evicted or not.

The process begins by identifying jobs and services corresponding to the pods deployed on nodes with high carbon emission, along with their SLAs and attributes (step 1200). In this step, high carbon emissions can be a node that is categorized as being a highest emission category. For example, categories can be low, medium, and high for the carbon emissions.

The process assesses a progress status for all the impacted jobs on the pod (step 1202). In step 1202, the impacted jobs are jobs that have been identified as running on nodes with high carbon emissions. In this assessment, if a job is nearing its completion on the pod, the pod running that job may not be a candidate for eviction. In another example, a pod corresponding to a machine learning (ML) training task may need to be terminated on a node with high carbon emission and re-scheduled to a different node.

The process assesses a progress status of currently handled workloads by each impacted service (step 1204). In step 1204, impacted services are services that use pods on nodes with high carbon emissions. In this example, the service level agreements for these workloads are considered. A workload can be for a task that runs for a job for a service on the pod.

If a long running workload is nearing its completion or the workload service level agreement violation costs are high, eviction of the pod being assessed can be delayed. For example, a pod may need to wait for the completion of a subset of ongoing machine learning (ML) inferencing tasks before getting evicted by terminating a different subset of ML inferencing tasks that may be run again on a different pod.

The process identifies placement options for the pod to be evicted considering nodes of the same cluster or across multiple clusters (step 1206).

The process determines whether the pod is to be evicted based on minimizing the service level agreement violations for the service and the service level agreement violations for the workload along with carbon emissions for the node (step 1208). The process terminates thereafter. In step 1208, if a major impact on the service level agreement violations for the service and the service level agreement violations for the workload is absent, then the determination is that the pod can be evicted.

For example, pod 1, pod 2, and pod 3, correspond to three different services that run on a node with high carbon emission. The SLA violation cost for the service (or for the workloads handled by that service) corresponding to pod 1 may be high while the SLA violation cost for the services corresponding to pod 2 and pod 3 are low. With this example, the decision can be to evict pod 2 and pod 3 from the node. These pods can be re-scheduled at a later time.

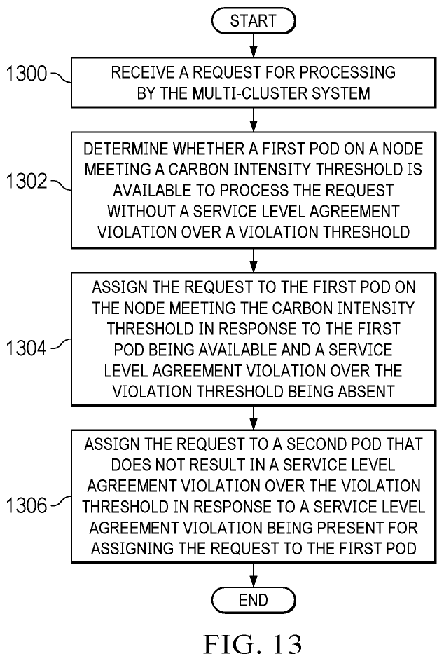

With reference next to FIG. 13, a flowchart of a process for assigning a request in a multi-cluster system is depicted in accordance with the illustrative embodiment. The process in FIG. 13 can be implemented in hardware, software, or both. When implemented in software, the process can take the form of program instructions that are run by a processor set located in one or more hardware devices in one or more computer systems. For example, the process can be implemented in cluster manager 214 in computer system 212 in FIG. 2.

The process begins by receiving a request for processing by the multi-cluster system (step 1300). The process determines whether a first pod on a node meeting a carbon intensity threshold is available to process the request without a service level agreement violation over a violation threshold (step 1302).

The process assigns the request to the first pod on the node meeting the carbon intensity threshold in response to the first pod being available and a service level agreement violation over the violation threshold being absent (step 1304). The process assigns the request to a second pod that does not result in a service level agreement violation over the violation threshold in response to a service level agreement violation being present for assigning the request to the first pod (step 1306). The process terminates thereafter.

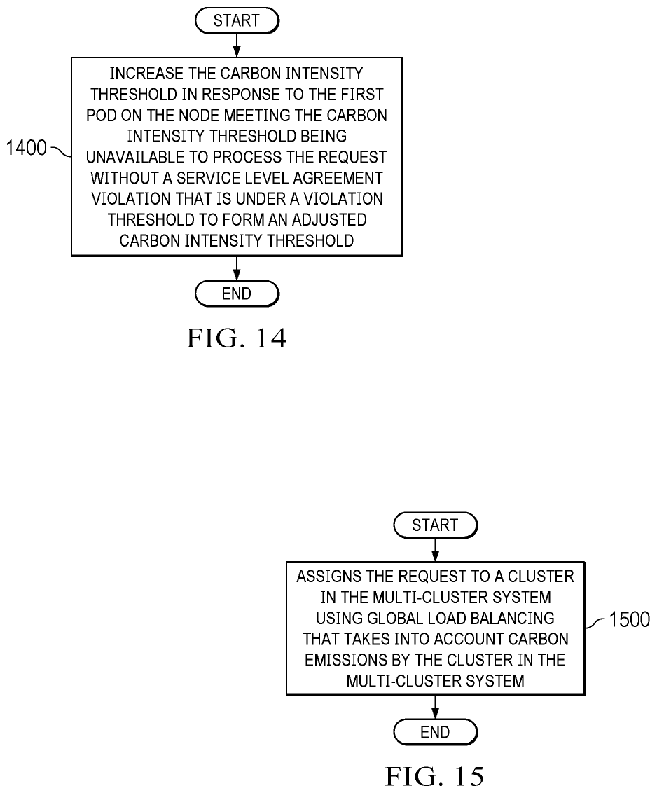

Next in FIG. 14, a flowchart of a process for adjusting a carbon intensity threshold is depicted in accordance with an illustrative embodiment. The process in this flowchart is an example of an additional step that can be performed with the steps in the flowchart in FIG. 13.

The process increases the carbon intensity threshold in response to the first pod on the node meeting the carbon intensity threshold being unavailable to process the request without a service level agreement violation that is under a violation threshold to form an adjusted carbon intensity threshold (step 1400). The process terminates thereafter.

In this illustrative example, the process can be used to make adjustments to carbon intensity threshold 287 in FIG. 2 in different situations. For example, cluster manager 214 can increase carbon intensity threshold 287 in response to first pod 282 on node 285 meeting carbon intensity threshold 287 being unavailable to process request 281 without service level agreement violation 283 to form adjusted carbon intensity threshold 286. In this example, first pod 282 can process request 281. However, node 285 has carbon emissions that exceed carbon intensity threshold 287. By increasing carbon intensity threshold 287 to obtain adjusted carbon intensity threshold 286, it may become possible for first pod 282 to process request 281 on node 285 in a manner that meets carbon emissions requirements. In this example, this type of change can be made when first pod 282 handles high-priority requests but node 285 exceeds carbon intensity threshold 287 needed to assign request 281 to first pod 282.

Turning next to FIG. 15, a flowchart of a process for assigning a request cluster is depicted in accordance with an illustrative embodiment. This process is an example of an additional step that can be performed with the process in FIG. 13.

The process assigns the request to a cluster in the multi-cluster system using global load balancing that takes into account carbon emissions by the cluster in the multi-cluster system (step 1500). The process terminates thereafter.

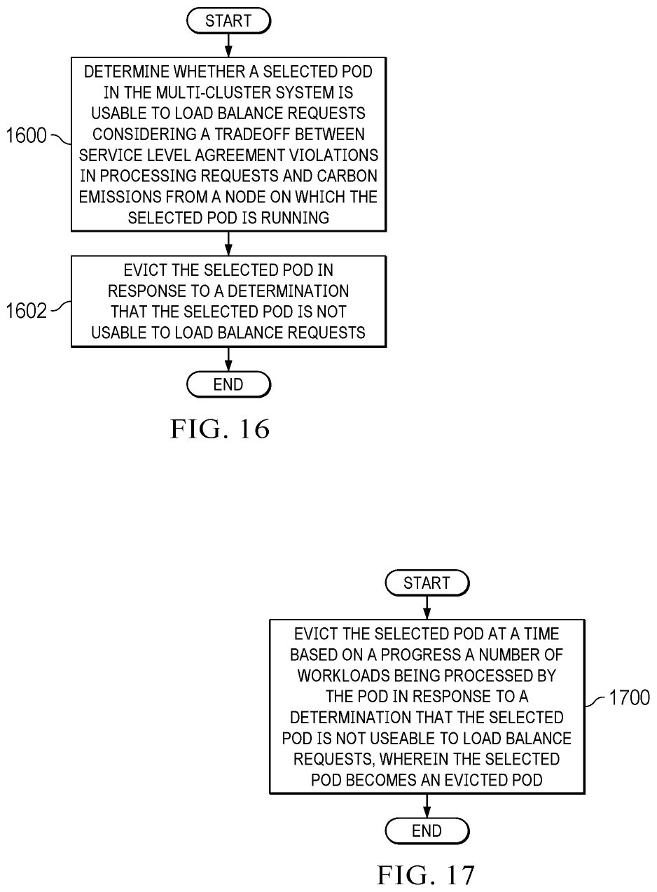

Next in FIG. 16, a flowchart of a process for identifying usable a pod is depicted in accordance with an illustrative embodiment. The flowchart is an example of additional steps that can be performed with the process in FIG. 13.

The process determines whether a selected pod in the multi-cluster system is usable to load balance requests considering a tradeoff between service level agreement violations in processing requests and carbon emissions from a node on which the selected pod is running (step 1600). The process evicts the selected pod in response to a determination that the selected pod is not usable to load balance requests (step 1602). The process terminates thereafter.

With reference next to FIG. 17, a flowchart of a process for evicting a pod is depicted in accordance with an illustrative embodiment. The process in this flowchart is an example of an implementation for step 1602 in FIG. 16.

The process evicts the selected pod at a time based on a progress of a number of workloads being processed by the pod in response to a determination that the selected pod is not usable to load balance requests, wherein the selected pod becomes an evicted pod (step 1700). The process terminates thereafter.

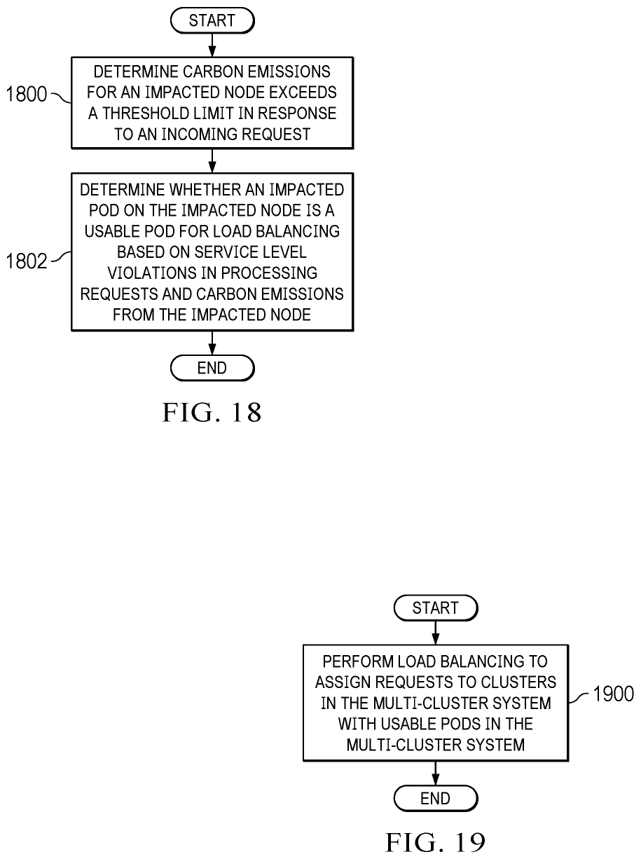

With reference next to FIG. 18, a flowchart of a process for determining the usability of a pod is depicted in accordance with an illustrative embodiment. This process is an example of additional steps that can be performed with the steps in FIG. 13.

The process determines whether carbon emissions for an impacted node exceed a threshold limit in response to an incoming request (step 1800). The process determines whether an impacted pod on the impacted node is a usable pod for load balancing based on service level violations in processing requests and carbon emissions from the impacted node (step 1802). The process terminates thereafter.

Next in FIG. 19, a flowchart of a process for performing load balancing with a usable pod is depicted in accordance with an illustrative embodiment. This process is an example of an additional step that can be performed with the process in FIG. 18.

The process performs load balancing to assign requests to clusters in the multi-cluster system with usable pods in the multi-cluster system (step 1900). The process terminates thereafter.

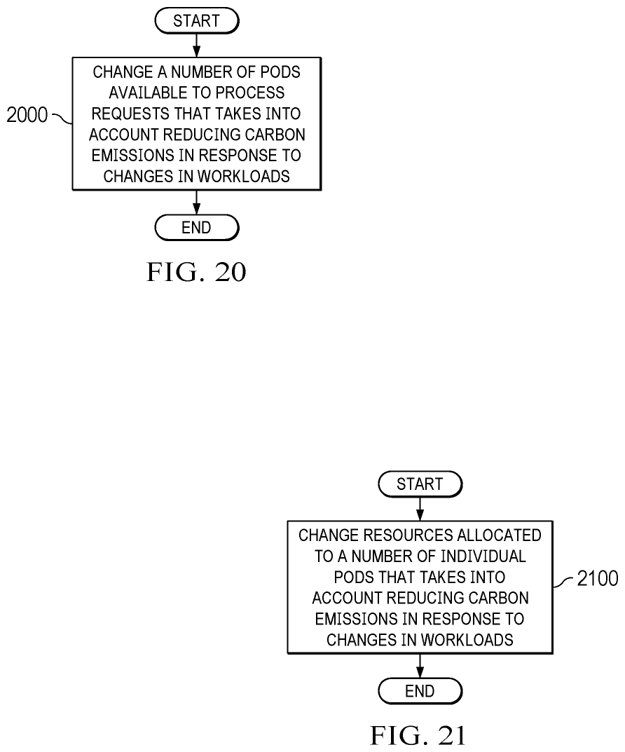

With reference now to FIG. 20, a flowchart of a process for changing pod availability is depicted in accordance with an illustrative embodiment. The process in FIG. 20 is an example of an additional step that can be performed with the steps in FIG. 13. The process in this flowchart can be implemented using horizontal pod autoscaling (HPA) that takes into account carbon emissions. In this manner, the number of pods can be increased or decreased depending on workloads requests and carbon emissions.

The process changes a number of pods available to process requests that takes into account reducing carbon emissions in response to changes in workloads (step 2000). The process terminates thereafter.

In step 2000, the number of pods can be reduced such that less pods are run for nodes that have carbon emissions in higher categories or at higher levels. Additionally, pods can be removed that run on nodes that have carbon emissions that exceed a carbon intensity threshold.

Next in FIG. 21, a flowchart of a process for changing resource availability is depicted in accordance with an illustrative embodiment. The process in this figure is an example of an additional step that can be performed with the steps in FIG. 13. The process in this flowchart can be implemented using vertical pod autoscaling (VPA) that takes into account carbon emissions.

The process changes resources allocated to a number of individuals pods that takes into account reducing carbon emissions in response to changes in workloads (step 2100). The process terminates thereafter.

In this illustrative example, the resource allocations can include processor resources, memory, and other resources. These resource allocations can be increased or decreased in a manner that takes into account changes in workloads for processing requests for services. These changes are made to reduce service level violations and take into account carbon emissions.

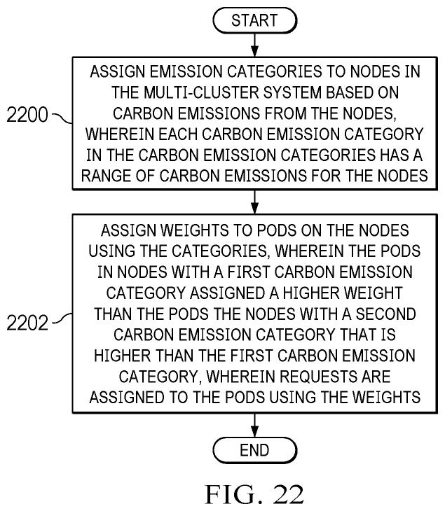

With reference now to FIG. 22, a flowchart of a process for assigning weights to pods is depicted in accordance with an illustrative embodiment. The process in this flowchart is an example of additional steps that can be performed with the process in FIG. 13.

The process begins by assigning emission categories to nodes in the multi-cluster system based on carbon emissions from the nodes, wherein each carbon emission category in the carbon emission categories has a range of carbon emissions for the nodes (step 2200). The process assigns weights to pods on the nodes using the categories, wherein the pods in the nodes with a first carbon emission category are assigned a higher weight than the pods in the nodes with a second carbon emission category that is higher than the first carbon emission category, wherein requests are assigned to the pods using the weights (step 2202). The process terminates thereafter.

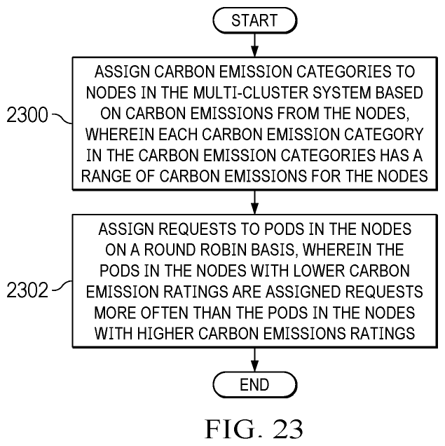

Next in FIG. 23, a flowchart of a process for assigning requests to pods using a load balancing policy is depicted in accordance with an illustrative embodiment. The steps in this flowchart are additional steps that can be performed with the steps in FIG. 13.

The process assigns carbon emission categories to nodes in the multi-cluster system based on carbon emissions from the nodes, wherein each carbon emission category in the carbon emission categories has a range of carbon emissions for the nodes (step 2300). The process assigns requests to pods in the nodes on a round robin basis, wherein the pods in the nodes with lower carbon emission ratings are assigned requests more often than the pods in the nodes with higher carbon emissions ratings (step 2302). The process terminates thereafter.

For example, pods can be assigned categories as low, medium, and high based on the carbon emission associated with the nodes on which the pods are running. Ranges of carbon emissions may be used to set these categories. Further, these ranges can also be set considering the amount of workload to be scheduled and workload service level agreements.

For example, if the amount of workload is high or workload service level agreement violations are sensitive, then pods on nodes with moderate carbon emissions also may be labeled as low. With the categorization of pods, pods that are categorized as low may be considered in each iteration of the round-robin policy; pods that are categorized as medium may be considered in each second iteration of the round-robin policy; and pods that are categorized as high may be considered in each third iteration of the round-robin policy.

Also, if the incoming request rate is sufficiently low, then only pods that are categorized as low are considered for load balancing assuming those pods that are low are sufficient to service the requests without service level agreement violations. With higher levels of requests, all pods may be considered in assigning requests to pods.

In this example, pods can also be assigned weights based on carbon emissions. Higher weights can be assigned for pods running on nodes with lower carbon emissions. For example, with three pods for a service, a first pod runs on a first node that is high, and the second pods runs on a second node that is low, and the third pod runs on a third node that is low. If two requests are from clients with low service level violation costs, then the first pod is considered for load balancing. These requests may be directed to the second pod or the third pod for processing.

The flowcharts and block diagrams in the different depicted embodiments illustrate the architecture, functionality, and operation of some possible implementations of apparatuses and methods in an illustrative embodiment. In this regard, each block in the flowcharts or block diagrams may represent at least one of a module, a segment, a function, or a portion of an operation or step. For example, one or more of the blocks can be implemented as program instructions, hardware, or a combination of the program instructions and hardware. When implemented in hardware, the hardware may, for example, take the form of integrated circuits that are manufactured or configured to perform one or more operations in the flowcharts or block diagrams. When implemented as a combination of program instructions and hardware, the implementation may take the form of firmware. Each block in the flowcharts or the block diagrams can be implemented using special purpose hardware systems that perform the different operations or combinations of special purpose hardware and program instructions run by the special purpose hardware.

In some alternative implementations of an illustrative embodiment, the function or functions noted in the blocks may occur out of the order noted in the figures. For example, in some cases, two blocks shown in succession can be performed substantially concurrently, or the blocks may sometimes be performed in the reverse order, depending upon the functionality involved. Also, other blocks can be added in addition to the illustrated blocks in a flowchart or block diagram.

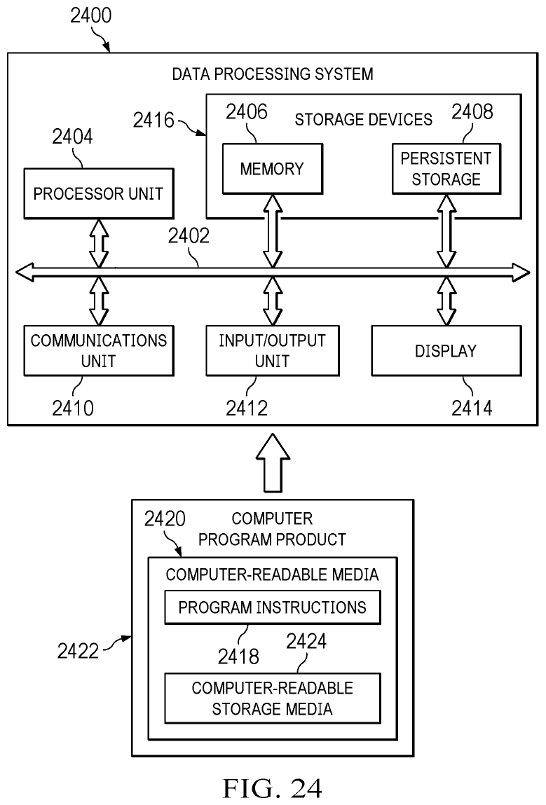

Turning now to FIG. 24, a block diagram of a data processing system is depicted in accordance with an illustrative embodiment. Data processing system 2400 can be used to implement computers and computing devices in computing environment 100 in FIG. 1. Data processing system 2400 can also be used to implement computer system 212 in FIG. 2. In this illustrative example, data processing system 2400 includes communications framework 2402, which provides communications between processor unit 2404, memory 2406, persistent storage 2408, communications unit 2410, input/output (I/O) unit 2412, and display 2414. In this example, communications framework 2402 takes the form of a bus system.

Processor unit 2404 serves to execute instructions for software that can be loaded into memory 2406. Processor unit 2404 includes one or more processors. For example, processor unit 2404 can be selected from at least one of a multicore processor, a central processing unit (CPU), a graphics processing unit (GPU), a physics processing unit (PPU), a digital signal processor (DSP), a network processor, or some other suitable type of processor. Further, processor unit 2404 can be implemented using one or more heterogeneous processor systems in which a main processor is present with secondary processors on a single chip. As another illustrative example, processor unit 2404 can be a symmetric multi-processor system containing multiple processors of the same type on a single chip.

Memory 2406 and persistent storage 2408 are examples of storage devices 2416. A storage device is any piece of hardware that is capable of storing information, such as, for example, without limitation, at least one of data, program instructions in functional form, or other suitable information either on a temporary basis, a permanent basis, or both on a temporary basis and a permanent basis. Storage devices 2416 may also be referred to as computer-readable storage devices in these illustrative examples. Memory 2406, in these examples, can be, for example, a random-access memory or any other suitable volatile or non-volatile storage device. Persistent storage 2408 may take various forms, depending on the particular implementation.

For example, persistent storage 2408 may contain one or more components or devices. For example, persistent storage 2408 can be a hard drive, a solid-state drive (SSD), a flash memory, a rewritable optical disk, a rewritable magnetic tape, or some combination of the above. The media used by persistent storage 2408 also can be removable. For example, a removable hard drive can be used for persistent storage 2408.

Communications unit 2410, in these illustrative examples, provides for communications with other data processing systems or devices. In these illustrative examples, communications unit 2410 is a network interface card.

Input/output unit 2412 allows for input and output of data with other devices that can be connected to data processing system 2400. For example, input/output unit 2412 may provide a connection for user input through at least one of a keyboard, a mouse, or some other suitable input device. Further, input/output unit 2412 may send output to a printer. Display 2414 provides a mechanism to display information to a user.

Instructions for at least one of the operating system, applications, or programs can be located in storage devices 2416, which are in communication with processor unit 2404 through communications framework 2402. The processes of the different embodiments can be performed by processor unit 2404 using computer-implemented instructions, which may be located in a memory, such as memory 2406.

These instructions are referred to as program instructions, computer usable program instructions, or computer-readable program instructions that can be read and executed by a processor in processor unit 2404. The program instructions in the different embodiments can be embodied on different physical or computer-readable storage media, such as memory 2406 or persistent storage 2408.

Program instructions 2418 are located in a functional form on computer-readable media 2420 that is selectively removable and can be loaded onto or transferred to data processing system 2400 for execution by processor unit 2404. Program instructions 2418 and computer-readable media 2420 form computer program product 2422 in these illustrative examples. In the illustrative example, computer-readable media 2420 is computer-readable storage media 2424.

Computer-readable storage media 2424 is a physical or tangible storage device used to store program instructions 2418 rather than a medium that propagates or transmits program instructions 2418. Computer-readable storage media 2424, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Alternatively, program instructions 2418 can be transferred to data processing system 2400 using a computer-readable signal media. The computer-readable signal media are signals and can be, for example, a propagated data signal containing program instructions 2418. For example, the computer-readable signal media can be at least one of an electromagnetic signal, an optical signal, or any other suitable type of signal. These signals can be transmitted over connections, such as wireless connections, optical fiber cable, coaxial cable, a wire, or any other suitable type of connection.

Further, as used herein, “computer-readable media 2420” can be singular or plural. For example, program instructions 2418 can be located in computer-readable media 2420 in the form of a single storage device or system. In another example, program instructions 2418 can be located in computer-readable media 2420 that is distributed in multiple data processing systems. In other words, some instructions in program instructions 2418 can be located in one data processing system while other instructions in program instructions 2418 can be located in one data processing system. For example, a portion of program instructions 2418 can be located in computer-readable media 2420 in a server computer while another portion of program instructions 2418 can be located in computer-readable media 2420 located in a set of client computers.

The different components illustrated for data processing system 2400 are not meant to provide architectural limitations to the manner in which different embodiments can be implemented. In some illustrative examples, one or more of the components may be incorporated in or otherwise form a portion of, another component. For example, memory 2406, or portions thereof, may be incorporated in processor unit 2404 in some illustrative examples. In other examples, more than one processor unit can be present. The different illustrative embodiments can be implemented in a data processing system including components in addition to or in place of those illustrated for data processing system 2400. Other components shown in FIG. 24 can be varied from the illustrative examples shown. The different embodiments can be implemented using any hardware device or system capable of running program instructions 2418.

Thus, the illustrative examples provide a computer implemented method, apparatus, computer system, and computer program product for routing requests. In one illustrative example, a computer implemented method for assigning a request in a multi-cluster system. A processor set receives the request for processing by the multi-cluster system. The processor set determines whether a first pod on a node meeting a carbon intensity threshold is available to process the request without a service level agreement violation over a violation threshold. The processor set assigns the request to the first pod on the node meeting the carbon intensity threshold in response to the first pod being available and a service level agreement violation over the violation threshold being absent. The processor set assigns the request to a second pod that does not result in a service level agreement violation over the violation threshold in response to a service level agreement violation being present for assigning the request to the first pod.

In these examples, different load-balancing policies can be employed to routes requests for a service at least one of clusters or nodes within a cluster in a manner patient carbon emissions. Further, the different illustrative examples can manage pods and resources assigned to bonds used to process requests. In these examples, on bottom managing routing requests, pods, and resources with respect service, carbon emissions can be taken into account in processing requests for the service. This management of clusters can include horizontal pod autoscaling, vertical pot autoscaling, rescheduling of pots, pot eviction, and other techniques that are performed taking into account carbon emissions. As result, carbon emissions can be reduced in providing a service as well meeting service level agreements for the service.

The description of the different illustrative embodiments has been presented for purposes of illustration and description and is not intended to be exhaustive or limited to the embodiments in the form disclosed. The different illustrative examples describe components that perform actions or operations. In an illustrative embodiment, a component can be configured to perform the action or operation described. For example, the component can have a configuration or design for a structure that provides the component an ability to perform the action or operation that is described in the illustrative examples as being performed by the component. Further, to the extent that terms “includes”, “including”, “has”, “contains”, and variants thereof are used herein, such terms are intended to be inclusive in a manner similar to the term “comprises” as an open transition word without precluding any additional or other elements.

The descriptions of the various embodiments of the present invention have been presented for purposes of illustration, but are not intended to be exhaustive or limited to the embodiments disclosed. Not all embodiments will include all of the features described in the illustrative examples. Further, different illustrative embodiments may provide different features as compared to other illustrative embodiments. Many modifications and variations will be apparent to those of ordinary skill in the art without departing from the scope and spirit of the described embodiment. The terminology used herein was chosen to best explain the principles of the embodiment, the practical application or technical improvement over technologies found in the marketplace, or to enable others of ordinary skill in the art to understand the embodiments disclosed here.

What is claimed is:

1. A computer implemented method for assigning a request in a multi-cluster system, the computer implemented method comprising:
receiving, by a processor set, the request for processing by the multi-cluster system;
determining, by the processor set, whether a first pod on a node meeting a carbon intensity threshold is available to process the request without a service level agreement violation over a violation threshold;
assigning, by the processor set, the request to the first pod on the node meeting the carbon intensity threshold in response to the first pod being available and a service level agreement violation over the violation threshold being absent; and
assigning, by the processor set, the request to a second pod that does not result in a service level agreement violation over the violation threshold in response to a service level agreement violation being present for assigning the request to the first pod.

2. The computer implemented method of claim 1 further comprising:
increasing the carbon intensity threshold in response to the first pod on the node meeting the carbon intensity threshold being unavailable to process the request without a service level agreement violation that is under a violation threshold to form an adjusted carbon intensity threshold.

3. The computer implemented method of claim 1 further comprising:
assigning, by the processor set, the request to a cluster in the multi-cluster system using global load balancing that takes into account carbon emissions by the cluster in the multi-cluster system.

4. The computer implemented method of claim 1 further comprising:
determining, by the processor set, whether a selected pod in the multi-cluster system is usable to load balance requests considering a tradeoff between service level agreement violations in processing requests and carbon emissions from a node on which the selected pod is running; and
evicting, by the processor set, the selected pod in response to a determination that the selected pod is not usable to load balance requests.

5. The computer implemented method of claim 4, wherein evicting the selected pod comprises:
evicting, by the processor set, the selected pod at a time based on a progress of a number of workloads being processed by the pod in response to a determination that the selected pod is not usable to load balance requests, wherein the selected pod becomes an evicted pod.

6. The computer implemented method of claim 1 further comprising:
determining, by the processor set, carbon emissions for an impacted node exceeds a threshold limit in response to an incoming request; and
determining, by the processor set, whether an impacted pod on the impacted node is a usable pod for load balancing based on service level violations in processing requests and carbon emissions from the impacted node.

7. The computer implemented method of claim 1 further comprising:
performing, by the processor set, load balancing to assign requests to clusters in the multi-cluster system with usable pods in the multi-cluster system.

8. The computer implemented method of claim 1 further comprising:
changing, by the processor set, a number of pods available to process requests that takes into account reducing carbon emissions in response to changes in workloads.

9. The computer implemented method of claim 1 further comprising:
changing, by the processor set, resources allocated to a number of individual pods that takes into account reducing carbon emissions in response to changes in workloads.

10. The computer implemented method of claim 1 further comprising:
assigning, by the processor set, emission categories to nodes in the multi-cluster system based on carbon emissions from the nodes, wherein each carbon emission category in the carbon emission categories has a range of carbon emissions for the nodes; and
assigning, by the processor set, weights to pods on the nodes using the categories, wherein the pods in nodes with a first carbon emission category is assigned a higher weight than the pods in the nodes with a second carbon emission category that is higher than the first carbon emission category, wherein requests are assigned to the pods using the weights.

11. The computer implemented method of claim 1 further comprising:
assigning, by the processor set, carbon emission categories to nodes in the multi-cluster system based on carbon emissions from the nodes, wherein each carbon emission category in the carbon emission categories has a range of carbon emissions for the nodes; and
assigning, by the processor set, requests to pods in the nodes on a round robin basis, wherein the pods in the nodes with lower carbon emission ratings are assigned requests more often than the pods in the nodes with a higher carbon emissions ratings.

12. A computer system comprising:
a processor set;
a set of one or more computer-readable storage media; and
program instructions, collectively stored in the set of one or more storage media, for causing the processor set to perform the following computer operations:
receive a request for processing by a multi-cluster system;
determine whether a first pod on a node meeting a carbon intensity threshold is available to process the request without a service level agreement violation over a violation threshold;
assign the request to the first pod on the node meeting the carbon intensity threshold in response to the first pod being available and a service level agreement violation over the violation threshold being absent; and
assign the request to a second pod that does not result in a service level agreement violation over the violation threshold in response to a service level agreement violation being present for assigning the request to the first pod.

13. The computer system of claim 12, wherein the program instructions, collectively stored in the set of one or more storage media, further causes the processor set to perform a following computer operation:
increase the carbon intensity threshold in response to the first pod on the node meeting the carbon intensity threshold being unavailable to process the request without a service level agreement threshold violation to form an adjusted carbon intensity threshold.

14. The computer system of claim 12, wherein the program instructions, collectively stored in the set of one or more storage media, further causes the processor set to perform a following computer operation:
assign the request to a cluster in the multi-cluster system using global load balancing that takes into account carbon emissions by the cluster in the multi-cluster system.

15. The computer system of claim 12, wherein the program instructions, collectively stored in the set of one or more storage media, further causes the processor set to perform the following computer operations:
determine whether a selected pod in the multi-cluster system is usable to load balance requests considering a tradeoff between service level violations in processing requests and carbon emissions from a node on which the selected pod is running; and
evict the selected pod in response to a determination that the selected pod is not usable to load balance requests.

16. The computer system of claim 15, wherein as part of evicting the selected pod, the program instructions, collectively stored in the set of one or more storage media, further causes the processor set to perform the following computer operation comprises:
evict the selected pod at a time based on a progress of a number of workloads being processed by the pod in response to a determination that the selected pod is not usable to load balance requests, wherein the selected pod becomes an evicted pod.

17. The computer system of claim 12, wherein the program instructions, collectively stored in the set of one or more storage media, further causes the processor set to perform the following computer operations:
determine whether carbon emissions for an impacted node exceeds a threshold limit in response to an incoming request; and
determine whether an impacted pod on the impacted node is a usable pod for load balancing based on service level violations in processing requests and carbon emissions from the impacted node.

18. The computer system of claim 17, wherein the program instructions, collectively stored in the set of one or more storage media, further causes the processor set to perform a following computer operation:
perform multi-cluster load balancing to assign requests to clusters in the multi-cluster system with usable pods in the multi-cluster system.

19. The computer system of claim 12, wherein the program instructions, collectively stored in the set of one or more storage media, further causes the processor set to perform the following computer operations:
change a number of pods available to process requests that takes into account reducing carbon emissions in response to changes in workloads.

20. A computer program product for assigning a request in a multi-cluster system, the computer program product comprising:
a set of one or more computer-readable storage media;
program instructions, collectively stored in the set of one or more storage media, for causing a processor set to perform the following computer operations:
receive a request for processing by the multi-cluster system;
determine whether a first pod on a node meeting a carbon intensity threshold is available to process the request without a service level agreement violation over a violation threshold;
assign the request to the first pod on the node meeting the carbon intensity threshold in response to the first pod being available and a service level agreement violation over the violation threshold being absent; and
assign the request to a second pod that does not result in a service level agreement violation over the violation threshold in response to a service level agreement violation being present for assigning the request to the first pod.
